(19) United States
(12) Patent Application Publication
(10) Pub. No.: US 2024/0162704 A1
(43) Pub. Date: May 16, 2024

(54) INRUSH CURRENT SUPPRESSION CIRCUIT, CONVERTER SYSTEM, AND MOTOR DRIVE DEVICE

(71) Applicant: Fanuc Corporation, Minamitsuru-gun, Yamanashi (JP)

(72) Inventors: Hiroki Sugiura, Minamitsuru-gun, Yamanashi (JP); Shinichi Horikoshi, Minamitsuru-gun, Yamanashi (JP); Koujirou Sakai, Minamitsuru-gun, Yamanashi (JP)

(73) Assignee: Fanuc Corporation, Minamitsuru-gun, Yamanashi (JP)

(21) Appl. No.: 18/283,891

(22) PCT Filed: Apr. 2, 2021
(86) PCT No.: PCT/JP2021/014377

§ 371 Date: Sep. 25, 2023

(51) Int. Cl. H02H 9/00; H02H 9/02; H02M 1/00; H02M 7/5387

(52) U.S. Cl. CPC H02H 9/002; H02H 9/02; H02M 1/0077; H02M 7/53871

(57) ABSTRACT

This inrush current suppression circuit, which suppresses inrush current during pre-charging of a capacitor connected in parallel to the DC-output side of a converter that converts AC power supply voltage to DC voltage, includes: a resistor that is provided between the DC-output side of the converter and the capacitor, or that is provided on the AC-input side of the converter; a switch that is selectively switched between an open state, in which an electric circuit is formed with the resistor interposed, and a closed state, in which a short circuit is formed without the resistor interposed; an AC power supply voltage detection unit that detects whether the AC power supply voltage is inputted to the converter; and a switch control unit that switches the switch from the open state to the closed state after a prescribed time has elapsed from when the AC power supply voltage detection unit detects inputting of the AC power supply voltage to the converter.

### CROSS REFERENCE TO RELATED APPLICATIONS

This is the U.S. National Phase application of PCT/JP2021/014377, filed Apr. 2, 2021, the disclosure of which being incorporated herein by reference in its entirety for all purposes.

### FIELD OF THE INVENTION

The present invention relates to an inrush current suppression circuit, a converter system, and a motor drive device.

### BACKGROUND OF THE INVENTION

In a motor drive device that controls driving of a motor in a machine tool, a forming machine, an injection molding machine, an industrial machine, or various robots, alternating-current power input from an alternating-current power source is converted into direct-current power by a converter (rectifier circuit) and is output to a DC link, and further a direct-current voltage in the DC link is converted into alternating-current power by an inverter, and the alternating-current power is supplied as drive power of the motor. The DC link refers to a circuit section configured to electrically connect a direct-current output side of the converter and a direct-current input side of the inverter, and may also be referred to as “DC link unit”, “direct-current link”, “direct-current link unit”, “direct-current intermediate circuit”, or the like.

The DC link is provided with a capacitor having a function of suppressing pulsation of the direct-current output of the converter and a function of accumulating direct-current power. This capacitor may also be referred to as “DC link capacitor” or “smoothing capacitor”.

The capacitor provided in the DC link needs to be charged to a predetermined magnitude of voltage after the motor drive device is powered on and before the motor starts driving (i.e., before the inverter starts a power conversion operation). This charging may also be referred to as “pre-charging” or “initial charging”.

The motor drive device is powered on by switching an electromagnetic contactor provided on an alternating-current input side of the converter in the motor drive device from open (OFF) to close (ON). Pre-charging of the capacitor is started when the motor is powered on. Since the pre-charging is started from a state where no energy is accumulated in the capacitor, a large inrush current flows from the alternating-current power source to the DC link via the converter immediately after the motor drive device is powered on. In particular, as the capacitance of the capacitor increases, a larger inrush current is generated. For this reason, the DC link is generally provided with an inrush current suppression circuit that suppresses an inrush current generated immediately after the motor drive device is powered on. The inrush current suppression circuit may also be referred to as “pre-charging circuit” or “initial charging circuit”.

The inrush current suppression circuit includes a resistor and a switch connected in parallel to the resistor. The inrush current suppression circuit is provided between the direct-current output side of the converter and the capacitor or on the alternating-current input side of the converter. The open state where a contact point of the switch is opened (OFF) is maintained during the pre-charging period of the capacitor immediately after the motor drive device is powered on, and the closed state where the contact of the switch is closed (ON) is maintained during the normal operation period when the motor drive device drives the motor. For example, when the inrush current suppression circuit is provided between the direct-current output side of the converter and the capacitor, the open state where the switch is opened is maintained during the pre-charging period immediately after the motor drive device is powered on and before the motor starts driving. During this time, since the direct-current output from the converter flows into the capacitor through the resistor, the inrush current is suppressed. When the direct-current flows into the capacitor, and the capacitor is charged to a predetermined magnitude of a voltage, the switch in the inrush current suppression circuit is switched from the open state to the closed state, and the motor is ready to be driven. During the period when the motor is driven, the switch in the closed state forms a short circuit not via the resistor, and thus the direct-current output from the converter passes through not the resistor but the switch in the closed state.

For example, there is known an inrush current suppression circuit including: a suppression resistor that suppresses a current flowing to a smoothing capacitor in a capacitor input type power supply device; a switch part connected in series to the suppression resistor; an AC input type photocoupler in which a light emitting diode is connected in parallel to the suppression resistor, and a phototransistor is shifted to an ON-state when a current flows to the light emitting diode; and a control circuit that short-circuits the suppression resistor by controlling the switch part into an ON-state when the phototransistor is continued to be in an OFF-state for a predetermined reference time or longer (see, e.g., PTL 1).

For example, there is known an inrush current suppression circuit that is provided on a power source connection side of a power source device and suppresses an inrush current that instantaneously flows when the power is on, in which two sets of thermistors inserted in series to the power source are prepared, and the thermistor with a lower temperature is automatically selected and inserted when the power source is on (see, e.g., PTL 2).

### PATENT LITERATURE

[PTL 1] JP 2009-232484 A

[PTL 2] JP 2002-252921 A

### SUMMARY OF THE INVENTION

When the switch in the inrush current suppression circuit is switched from the open state to the closed state after completion of the pre-charging of the capacitor, the alternating-current power source and the capacitor are short-circuited via the converter, and thus a large current temporarily flows through the switch. At the time of switching from the open state to the closed state, a phenomenon called “bounce” occurs. Bounce is a mechanical vibration phenomenon in which a movable contact and a fixed contact of a switch repeat collision (contact) and repulsion (separation) in a short period of time. Bounce may also be referred to as “chattering”. While the bounce is occurring, when the movable contact and the fixed contact come into contact with each other, electricity is supplied, and when the movable contact and the fixed contact are separated from each other, electricity is not supplied. At this time, when the distance between the movable contact and the fixed contact is very short although they are separated from each other, insulation by air between the movable contact and the fixed contact is broken, and an arc occurs. The arc melts the movable contact and the fixed contact and causes a failure of the switch.

In order to suppress an occurrence of an arc when the switch in the inrush current suppression circuit is switched from the open state to the closed state, for example, a method may be used in which the switch is switched from the open state to the closed state at a time point when a difference between an alternating-current power source voltage peak value and the voltage of the DC link (hereinafter, referred to as “DC link voltage”) falls within a predetermined design value. However, in this method, it is necessary to provide a circuit configured to detect each of the alternating-current power source voltage peak value and the DC link voltage and a circuit configured to compare the alternating-current power source voltage peak value and the DC link voltage, which makes the circuit complicated.

Since the DC link voltage from the start to the end of the pre-charging of the capacitor changes according to the physical law, it is possible to estimate the time from the start of the pre-charging until the difference between the alternating-current power source voltage peak value and the DC link voltage falls within a predetermined design value. For this reason, a method may be used in which an occurrence of an arc is suppressed by switching the switch from the open state to the closed state based on this elapse of estimated time. As described above, the pre-charging of the capacitor is started from the time point when the electromagnetic contactor provided on the alternating-current input side of the converter is switched from OFF to ON. However, in setting of the motor drive device, in a case where the operator provides a safety sequence for the motor drive device during a series of operations from when a control unit of the converter commands start of pre-charging until the electromagnetic contactor is actually switched from OFF to ON, a time delay caused by the safety sequence occurs. Consequently, even when the switch is switched from the open state to the closed state based on the elapse of the estimated time, the difference between the alternating-current power source voltage peak value and the DC link voltage does not yet fall within a predetermined design value, and there is a possibility that an arc occurs.

For example, if the fact that the motor drive device is powered on is detected when an auxiliary contact of the electromagnetic contactor provided on the alternating-current input side of the converter in the motor drive device is turned on, it is possible to specify the timing of start of the pre-charging of the capacitor, and to avoid the problem of the time delay caused by the safety sequence as described above. However, it is necessary to provide a circuit and wiring configured to detect ON of the auxiliary contact of the electromagnetic contactor, which increases the man-hours by the operator to design and set the motor drive device.

By providing an alternating-current power source voltage peak value detection circuit that detects an alternating-current power source voltage peak value for the converter in the motor drive device, it is also possible to detect that the motor drive device is powered on. A diode is built in such alternating-current power source voltage peak value detection circuit, but there is a possibility that the diode is destroyed when a lightning surge occurs due to a lightning strike.

Thus, it is desirable to develop an inrush current suppression circuit with a simple structure and a long life so that an inrush current is suppressed at the time of pre-charging of a capacitor provided on the direct-current output side of the converter.

According to one aspect of the present disclosure, an inrush current suppression circuit that suppresses an inrush current during pre-charging of a capacitor connected in parallel to a direct-current output side of a converter that converts an alternating-current power source voltage into a direct-current voltage, includes: a resistor provided between the direct-current output side of the converter and the capacitor or on an alternating-current input side of the converter; a switch connected in parallel to the resistor and configured to selectively switch between an open state where an electric path via the resistor is formed and a closed state where a short circuit not via the resistor is formed; an alternating-current power source voltage detecting unit configured to detect whether or not the alternating-current power source voltage is input to the converter; and a switch control unit configured to switch the switch from the open state to the closed state after a predetermined time has elapsed since the alternating-current power source voltage detecting unit detects input of the alternating-current power source voltage to the converter.

According to one aspect of the present disclosure, a converter system includes a converter configured to convert an alternating-current power source voltage into a direct-current voltage, and the inrush current suppression circuit connected to the converter.

According to one aspect of the present disclosure, a motor drive device includes: the converter system; a capacitor connected in parallel to a direct-current output side of the converter in the converter system; and an inverter connected to the direct-current output side of the converter via the capacitor, and configured to convert a direct-current voltage on the direct-current output side of the converter into an alternating-current voltage for driving a motor and output the alternating-current voltage.

According to one aspect of the present disclosure, it is possible to achieve an inrush current suppression circuit, a converter system, and a motor drive device with a simple structure and a long life so that an inrush current is suppressed at the time of pre-charging of a capacitor provided on a direct-current output side of a converter.

### BRIEF DESCRIPTION OF DRAWINGS

FIG. 1 is a view illustrating an inrush current suppression circuit, a converter system, and a motor drive device according to one embodiment of the present disclosure.

FIG. 2 is a view illustrating a modified example of an alternating-current power source voltage detecting unit in the inrush current suppression circuit, the converter system, and the motor drive device according to one embodiment of the present disclosure.

FIG. 3 is a view illustrating a case where a resistor and a switch in the inrush current suppression circuit according to one embodiment of the present disclosure are provided on an alternating-current input side of a converter.

FIG. 4 is a view illustrating a case where a photocoupler in the inrush current suppression circuit according to one embodiment of the present disclosure is provided on all three-phase power lines connected to an alternating-current input side of a converter.

FIG. 5 is a flowchart illustrating an operation flow of the inrush current suppression circuit according to one embodiment of the present disclosure.

FIG. 6 is a view illustrating a conventional inrush current suppression circuit that determines whether or not to complete pre-charging of a capacitor, based on the result of a comparison between an alternating-current power source voltage peak value and a DC link voltage.

FIG. 7 is a view illustrating a conventional motor drive device that detects that the motor drive device is powered on when an auxiliary contact of an electromagnetic contactor provided on an alternating-current input side of a converter is turned on.

### DETAILED DESCRIPTION OF EMBODIMENTS OF THE INVENTION

An inrush current suppression circuit, a converter system, and a motor drive device will be described below with reference to the drawings. In the drawings, a similar member is given a similar reference sign. To facilitate understanding, scales of these drawings are appropriately changed. The embodiment illustrated in the drawings is one example for implementation, and the present invention is not limited to the illustrated embodiment.

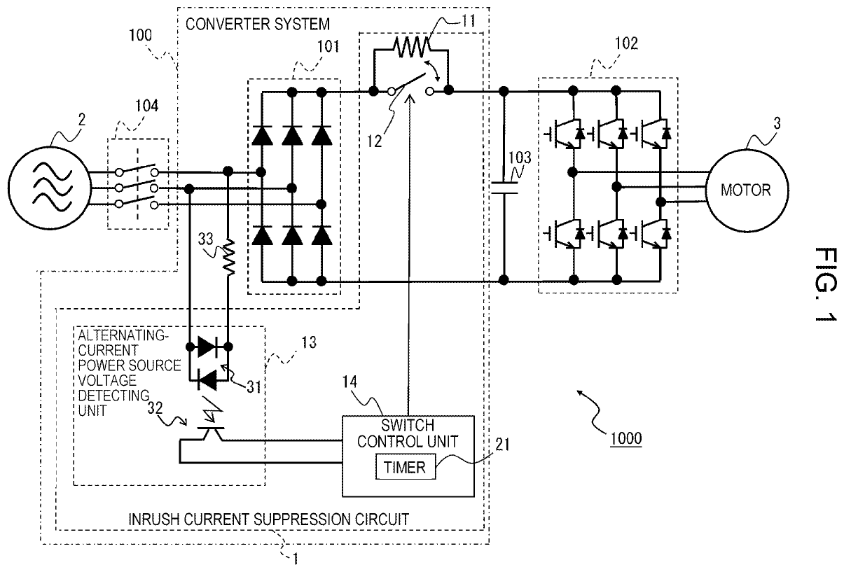

FIG. 1 is a view illustrating the inrush current suppression circuit, the converter system, and the motor drive device according to one embodiment of the present disclosure.

As an example, a case where a motor drive device 1000 connected to an alternating-current power source 2 controls a motor 3 will be described. In the present embodiment, the type of the motor 3 is not particularly limited, and may be, for example, an induction motor or a synchronous motor. The number of phases of the alternating-current power source 2 and the motor 3 is not particularly limited to the present embodiment, and may be, for example, three phases or a single phase. In the example illustrated in FIG. 1, the alternating-current power source 2 and the motor 3 have three phases. Examples of the alternating-current power source 2 include a three-phase alternating-current 400 V power source, a three-phase alternating-current 200 V power source, a three-phase alternating-current 600 V power source, and a single-phase alternating-current 100 V power source. Examples of the machine provided with the motor 3 include a machine tool, a robot, a forming machine, an injection molding machine, an industrial machine, various electrical appliances, a train, an automobile, and an aircraft.

As illustrated in FIG. 1, the motor drive device 1000 according to one embodiment of the present disclosure includes a converter system 100, an inverter 102, and a capacitor 103. The converter system 100 includes a converter 101 and an inrush current suppression circuit 1. The inrush current suppression circuit 1 may also be referred to as “pre-charging circuit” or “initial charging circuit”.

The motor drive device 1000 includes an electromagnetic contactor 104 that opens and closes an electric path between an alternating-current input side of the converter 101 in the converter system 100 and the alternating-current power source 2. In the electromagnetic contactor 104, a closed state where the alternating-current input side of the converter 101 and the alternating-current power source 2 are electrically connected to each other is achieved by closing (ON) a contact of the electromagnetic contactor 104, and an open state where the alternating-current input side of the converter 101 and the alternating-current power source 2 are electrically disconnected from each other is achieved by opening (OFF) the contact of the electromagnetic contactor 104. Before the motor drive device 1000 is powered on, the contact of the electromagnetic contactor 104 is in the open state, and the capacitor 103 is not charged. When the electromagnetic contactor 104 is switched from the open state to the closed state and the motor drive device 1000 is powered on, pre-charging of the capacitor 103 is started. It should be noted that, for example, a relay, a semiconductor switching element, or the like may be used in place of the electromagnetic contactor 104 as long as it can open and close the electric path between the alternating-current input side of the converter 101 and the alternating-current power source 2.

The converter 101 converts an alternating-current power source voltage input from the alternating-current power source 2 via the electromagnetic contactor 104 in the closed state into a direct-current voltage, and outputs this direct-current voltage to a DC link that is a direct-current output side of the converter 101. The converter 101 includes a three-phase bridge circuit in a case where the alternating-current power source 2 is a three-phase alternating-current power source, and includes a single-phase bridge circuit in a case where the alternating-current power source 2 is a single-phase alternating-current power source. In the example illustrated in FIG. 1, since the alternating-current power source 2 is a three-phase alternating-current power source, the converter 101 includes a three-phase bridge circuit. Examples of the converter 101 include a diode rectifier, a 120-degree conduction type rectifier, and a PWM switching control type rectifier. In the example illustrated in FIG. 1, the converter 101 includes a diode rectifier. For example, in a case where the converter 101 includes a 120-degree conduction type rectifier and a PWM switching control type rectifier, the converter 101 includes a bridge circuit of a switching element and a diode connected in antiparallel (inverse-parallel) to this, and ON/OFF of each switching element is controlled in response to a drive command received from a host controller (not illustrated) to perform power conversion in both alternating-current and direct-current bidirectional directions. In this case, examples of the switching element include an FET, an IGBT, a thyristor, a gate turn-off thyristor (GTO), and a transistor, although another semiconductor element may be used.

The capacitor 103 is connected in parallel to the direct-current output side of the converter 101. The capacitor 103 may also be referred to as “DC link capacitor” or “smoothing capacitor”. The capacitor 103 has a function of suppressing pulsation of the direct-current output of the converter 101 and a function of accumulating direct-current power used by the inverter 102 to generate alternating-current power. Examples of the capacitor 103 include an electrolytic capacitor and a film capacitor.

The inverter 102 is connected to the direct-current output side of the converter 101 via the capacitor 103, converts a direct-current voltage on the direct-current output side of the converter 101 into an alternating-current voltage for driving the motor 3, and outputs this alternating-current voltage to the alternating-current output side of the inverter 102. The inverter 102 includes a bridge circuit of a switching element and a diode connected in antiparallel (inverse-parallel) to this. The inverter 102 includes a three-phase bridge circuit in a case where the motor 3 is a three-phase alternating-current motor, and includes a single-phase bridge circuit in a case where the motor 3 is a single-phase alternating-current motor. In the example illustrated in FIG. 1, since the motor 3 is a three-phase alternating-current motor, the inverter 102 includes a three-phase bridge circuit. The power conversion operation of the inverter 102 is controlled by a PWM switching control type, for example.

That is, the inverter 102 receives a PWM switching command from the host controller (not illustrated), converts a direct-current voltage in the DC link into an alternating-current voltage for driving the motor 3, and outputs the alternating-current voltage to the motor 3, as well as, during motor regeneration, converting an alternating-current voltage regenerated by the motor 3 into a direct-current voltage and outputting the direct-current voltage to the DC link.

Similarly to a general motor drive device, the power conversion operation of the inverter 102 is controlled by the host controller (not illustrated). Specifically, the host controller generates a switching command for controlling the speed and torque of the motor 3 or the position of a rotor based on the speed (speed feedback) of the motor 3, the current (current feedback) flowing through the winding of the motor 3, a predetermined torque command, an operation program of the motor 3, and the like. The power conversion operation of the inverter 102 is controlled based on the PWM switching command created by the host controller.

The inrush current suppression circuit 1 is provided between the direct-current output side of the converter 101 and the capacitor 103 or on the alternating-current input side of the converter 101 in order to suppress an inrush current that may occur when the capacitor 103 is pre-charged (initially charged) before the motor drive device 1000 starts drive of the motor 3. In the example illustrated in FIG. 1, the inrush current suppression circuit 1 is provided between the direct-current output side of the converter 101 and the capacitor 103. More specifically, in the example illustrated in FIG. 1, the inrush current suppression circuit 1 is provided between a direct-current side positive electrode terminal of the converter 101 and a positive electrode terminal of the capacitor 103. Alternatively, the inrush current suppression circuit 1 may be provided between a direct-current side negative electrode terminal of the converter 101 and a negative electrode terminal of the capacitor 103.

The inrush current suppression circuit 1 includes a resistor 11, a switch 12, an alternating-current power source voltage detecting unit 13, and a switch control unit 14.

In the example illustrated in FIG. 1, the resistor 11 in the inrush current suppression circuit 1 is provided between the direct-current side positive electrode terminal of the converter 101 and the positive electrode terminal of the capacitor 103. It should be noted that although not illustrated here, in a case where the inrush current suppression circuit 1 is provided between the direct-current side negative electrode terminal of the converter 101 and the negative electrode terminal of the capacitor 103, the resistor 11 is provided between the direct-current side negative electrode terminal of the converter 101 and the negative electrode terminal of the capacitor 103.

The switch 12 is connected in parallel to the resistor 11. The switch 12 is selectively switched between the open state where the movable contact and the fixed contact are opened (OFF) and the closed state where the movable contact and the fixed contact are closed (ON) under the control of the switch control unit 14. Examples of the switch 12 include a semiconductor switching element such as a thyristor and an IGBT, and a mechanical switch such as a relay. When the switch 12 is in the open state, an electric path leading from the converter 101 to the capacitor 103 and the inverter 102 via the resistor 11 is formed. When the switch 12 is in the closed state, a short circuit not via the resistor 11 is formed, i.e., the converter 101 is directly connected to the capacitor 103 and the inverter 102 not via the resistor 11. Before the motor drive device 1000 is powered on, the switch 12 is in the open state. During the pre-charging period of the capacitor 103, the switch 12 is maintained in the open state, the current output from the converter 101 flows into the capacitor 103 as a charging current via the resistor 11, and the capacitor 103 is charged (pre-charged). During the pre-charging period of the capacitor 103, the current output from the converter 101 flows through the resistor 11, and thus an occurrence of an inrush current can be prevented. Thereafter, as described later, under the control of the switch control unit 14, the switch 12 is switched from the open state to the closed state, and the pre-charging of the capacitor 103 is completed. After completion of the pre-charging of the capacitor 103, the direct-current output from the converter 101 flows toward the inverter 102 and the capacitor 103 through the switch 12 in the closed state, and is shifted to a state where the motor 3 can be driven.

The alternating-current power source voltage detecting unit 13 detects whether or not an alternating-current power source voltage is input to the converter 101. The alternating-current power source voltage detecting unit 13 includes a photocoupler including a light emitting element 31 and a light receiving element 32. The light emitting element 31 is connected in series via a resistor 33 between phases of each phase power line connected to the alternating-current input side of the converter 101 (between lines of the phase power lines). Examples of the light emitting element 31 include a light emitting diode (LED). In the example illustrated in FIG. 1, a signal input terminal of the light emitting element 31 is connected between any phases (between lines) of, for example, an R-phase and an S-phase, the S-phase and a T-phase, and the T-phase and the R-phase. A signal output terminal of the light receiving element 32 is connected to the switch control unit 14. When receiving light emitted from the light emitting element 31, the light receiving element 32 outputs, to the switch control unit 14, a signal indicating that the alternating-current power source voltage is input to the converter 101. Examples of the light receiving element 32 include a phototransistor, a photo IC, a photothyristor, and a photodiode.

Before the motor drive device 1000 is powered on, since the contact of the electromagnetic contactor 104 is in the open state, a potential difference does not occur between the phases of each phase power line connected to the alternating-current input side of the converter 101, and therefore the light emitting element 31 does not emit light, whereby there is no signal output from the light receiving element 32. When the electromagnetic contactor 104 is switched from the open state to the closed state and the motor drive device 1000 is powered on, since a potential difference occurs between the phases of each phase power line connected to the alternating-current input side of the converter 101, the light emitting element 31 emits light, and the light receiving element 32 receives this light and outputs a signal. In this manner, the alternating-current power source voltage detecting unit 13 detects that “there is an input of the alternating-current power source voltage to the converter 101” based on “switching from a state where there is no signal output to a state where there is a signal output from the light receiving element 32”. The detection result by the alternating-current power source voltage detecting unit 13 is sent to the switch control unit 14.

In the example illustrated in FIG. 1, the light emitting element 31 includes two light emitting diodes connected in antiparallel (inverse-parallel) to each other with the conduction directions being opposite. Even if a lightning surge or the like occurs and an overvoltage (excessive potential difference) occurs between the phases of each phase power line connected to the alternating-current input side of the converter 101, only a voltage of about a forward voltage is applied to any one of the two light emitting diodes, and therefore the light emitting diodes are not destroyed. As a result, the inrush current suppression circuit 1 including the alternating-current power source voltage detecting unit 13 does not fail and has a long life.

The switch control unit 14 switches the switch 12 from the open state to the closed state after a predetermined time has elapsed since the alternating-current power source voltage detecting unit 13 detects input of the alternating-current power source voltage to the converter 101. For this reason, the switch control unit 14 includes a timer 21 that starts clocking from the time point when the alternating-current power source voltage detecting unit 13 detects input of the alternating-current power source voltage to the converter. When the time clocked by the timer 21 reaches the predetermined time, the switch control unit 14 switches the switch 12 from the open state to the closed state.

The “predetermined time” used for the clocking by the timer 21 in the switch control unit 14 needs to be acquired in advance before actual operation of the motor drive device 1000. The “predetermined time” is set to, for example, a time required from when the electromagnetic contactor 104 is switched from the open state to the closed state to when the pre-charging of the capacitor 103 via the resistor 11 is completed. The voltage at the time of completion of the pre-charging of the capacitor 103 is set to a value, for example, lower than the alternating-current power source voltage peak value by a predetermined design value. For example, the “predetermined time” can be acquired by performing calculation in advance according to physical laws such as Ohm's law and Kirchhoff's law by using various parameters such as the voltage value of the alternating-current power source 2, the resistance value of the resistor 11, the losses of the capacitor 103 and the converter 101, and the resistance value and the inductance of each power line. Alternatively, the “predetermined time” may be acquired (measured) by operating the motor drive device 1000 through an experiment, or the “predetermined time” may be acquired on the basis of a simulation result by a computer. The acquired “predetermined time” is defined in a software program for constructing the timer 21 in the switch control unit 14. Alternatively, the value of the “predetermined time” may be stored in, for example, a storage (not illustrated) in the switch control unit 14, and the timer 21 may be caused to read this stored “predetermined time” to clock the time. The storage includes, for example, an electrically erasable/recordable nonvolatile memory such as EEPROM (registered trademark), or a random access memory that can read and write at a high speed such as DRAM or SRAM. It should be noted that if the storage is achieved by a rewritable memory, the value can be changed to an appropriate value as necessary, even after the “predetermined time” has been set.

The switch control unit 14 and the host controller (not illustrated) may include a combination of an analog circuit and an arithmetic processing device, may include only an arithmetic processing device, or may include only an analog circuit. For example, in a case where the switch control unit 14 and the host controller are constructed in a software program format, the functions of the switch control unit 14 and the host controller can be achieved by causing the arithmetic processing device to operate according to this software program. Alternatively, the switch control unit 14 and the host controller may be achieved as a semiconductor integrated circuit in which a software program for achieving the function of each unit is written. Alternatively, the switch control unit 14 and the host controller may be achieved as a recording medium in which a software program for achieving the function of each unit is written. For example, in a case where the converter 101 includes a 120-degree conduction type rectifier or a PWM switching control type rectifier, the switch control unit 14 may be provided in a control device configured to control the power conversion operation of the converter 101. Alternatively, the switch control unit 14 may be provided, for example, in a numerical control device of a machine tool or may be provided in a robot controller that controls a robot.

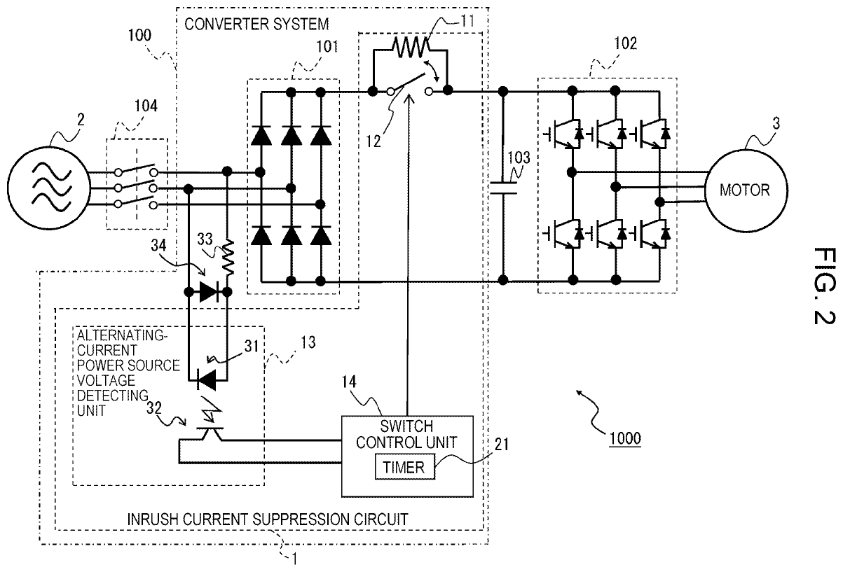

The light emitting element 31 in the photocoupler in the alternating-current power source voltage detecting unit 13 illustrated in FIG. 1 includes the two light emitting diodes connected in antiparallel to each other. As this modified example, the configuration of the light emitting element 31 may be further simplified. FIG. 2 is a view illustrating a modified example of the alternating-current power source voltage detecting unit in the inrush current suppression circuit, the converter system, and the motor drive device according to one embodiment of the present disclosure. As illustrated in FIG. 2, the light emitting element 31 includes one light emitting diode, and a non-light emitting diode 34 is connected in parallel with the conduction direction being opposite to the light emitting element 31 (light emitting diode). The example illustrated in FIG. 2 has an advantage that the light emitting diode can be replaced with the non-light emitting diode 34, which is inexpensive as compared with the example illustrated in FIG. 1. On the other hand, the example illustrated in FIG. 1 has an advantage that detection delay of the alternating-current power source voltage is small as compared with the example illustrated in FIG. 2. It should be noted that since other circuit components are similar to the circuit components illustrated in FIG. 1, the same circuit components are given the same reference signs, and detailed descriptions of the circuit components will be omitted.

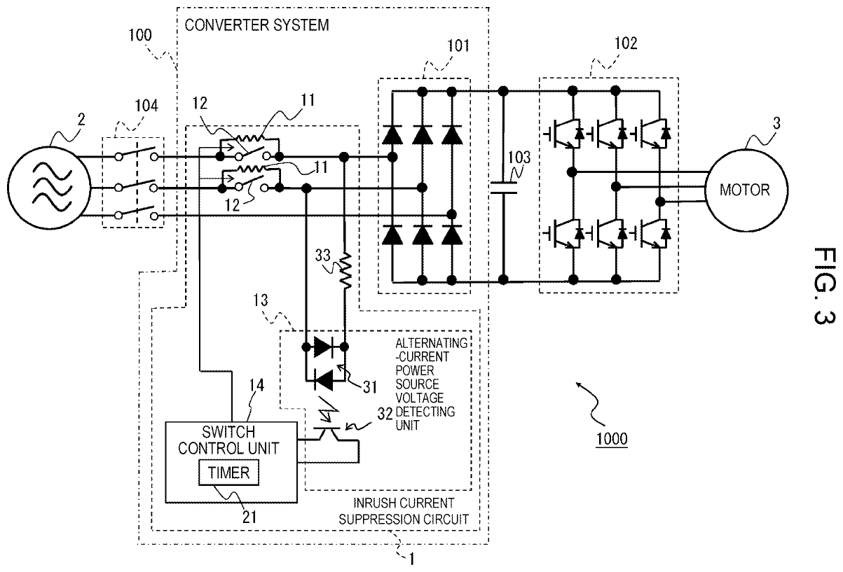

FIG. 3 is a view illustrating a case where a resistor and a switch in the inrush current suppression circuit according to one embodiment of the present disclosure are provided on the alternating-current input side of the converter. The example illustrated in FIG. 3 illustrates a case where a set including the resistor 11 and the switch 12 in the inrush current suppression circuit 1 is provided on a power line for two phases of the three phases on the alternating-current input side of the converter 101. In the example illustrated in FIG. 3, the light emitting element 31 in the alternating-current power source voltage detecting unit 13 is provided between the phases (between lines) of the power line for two phases provided with the set including the resistor 11 and the switch 12. As this modified example, the light emitting element 31 of the photocoupler in the alternating-current power source voltage detecting unit 13 may be provided between the phases (between lines) of a power line for one phase provided with the set including the resistor 11 and the switch 12 and a power line for one phase not provided with the set including the resistor 11 and the switch 12. The set of the resistor 11 and the switch 12 may be provided on all the three-phase power lines on the alternating-current input side of the converter 101. It should be noted that since other circuit components are similar to the circuit components illustrated in FIG. 1, the same circuit components are given the same reference signs, and detailed descriptions of the circuit components will be omitted.

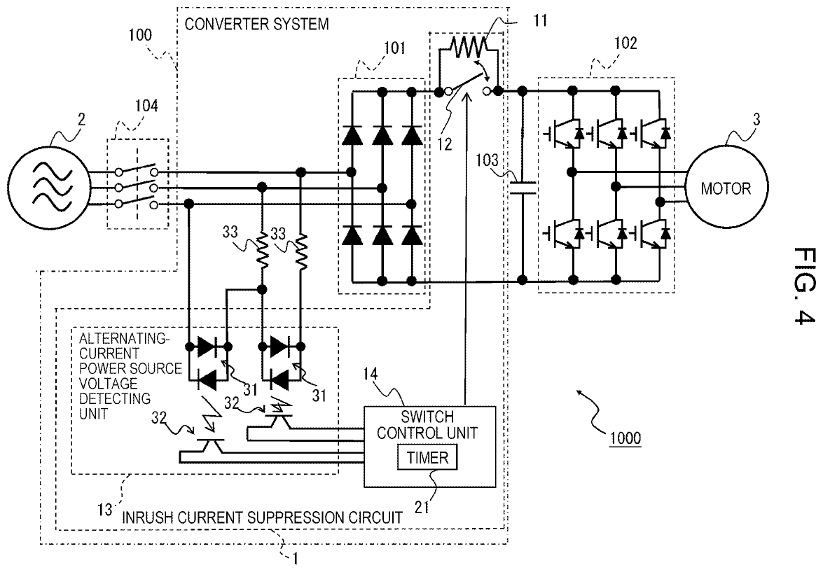

FIG. 4 is a view illustrating a case where a photocoupler in the inrush current suppression circuit according to one embodiment of the present disclosure is provided on all three-phase power lines connected to the alternating-current input side of the converter. As illustrated in FIG. 4, in a case where the photocouplers in the alternating-current power source voltage detecting unit 13 are provided on all the three-phase power lines connected to the alternating-current input side of the converter, two photocouplers are required. By calculating a logical sum of the signals output from the light receiving elements 32 of the two photocouplers, the switch control unit 14 can detect that “there is an input of the alternating-current power source voltage to the converter 101” when a signal is output from any one of the two light receiving elements 32. Therefore, the example of the two photocouplers illustrated in FIG. 4 has an advantage that the detection delay is small as compared with the example of the one photocoupler illustrated in FIG. 1. The example of the two photocouplers illustrated in FIG. 4 has an advantage that even if there is an open phase in which one phase of the three phases of the alternating-current power source 2 fails, the photocoupler connected to the power line of the remaining normal two-phases can detect “there is an input of the alternating-current power source voltage to the converter 101”. In the example illustrated in FIG. 4, the set including the resistor 11 and the switch 12 in the inrush current suppression circuit 1 is provided on the direct-current output side of the converter 101, but may be provided on a three-phase power line or a two-phase power line on the alternating-current input side. Since other circuit components are similar to the circuit components illustrated in FIG. 1, the same circuit components are given the same reference signs, and detailed descriptions of the circuit components will be omitted.

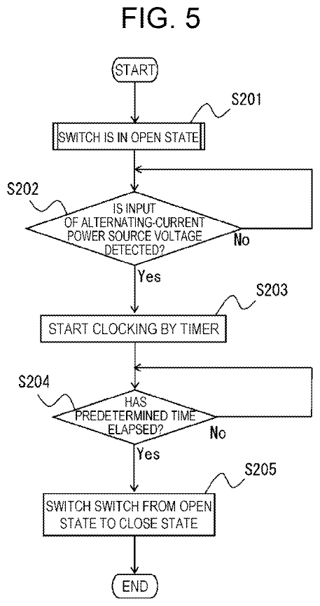

FIG. 5 is a flowchart illustrating an operation flow of the inrush current suppression circuit according to one embodiment of the present disclosure.

Before the motor drive device 1000 is powered on, the contact of the electromagnetic contactor 104 is in the open state, and the capacitor 103 is not charged. At this time, the switch 12 is in the open state (step S201).

In step S202, the alternating-current power source voltage detecting unit 13 detects whether or not the alternating-current power source voltage is input to the converter 101. When the electromagnetic contactor 104 is switched from the open state to the closed state and the motor drive device 1000 is powered on, pre-charging of the capacitor 103 is started. During the pre-charging period of the capacitor 103, the switch 12 is maintained in the open state, the current output from the converter 101 flows into the capacitor 103 as a charging current via the resistor 11. During the pre-charging period of the capacitor 103, the current output from the converter 101 flows through the resistor 11, and thus an occurrence of an inrush current can be prevented. When the electromagnetic contactor 104 is switched from the open state to the closed state, a voltage occurs between the phases of each phase power line connected to the alternating-current input side of the converter 101, and thus the light emitting element 31 emits light, and the light receiving element 32 receives this light and outputs a signal. When detecting “switching from a state where there is no signal output to a state where there is a signal output from the light receiving element 32”, the alternating-current power source voltage detecting unit 13 determines that there is detection of an input of the alternating-current power source voltage to the converter 101, and the process proceeds to step S203. The detection result by the alternating-current power source voltage detecting unit 13 is sent to the switch control unit 14.

In step S203, the timer 21 in the switch control unit 14 starts clocking from the time point when the alternating-current power source voltage detecting unit 13 detects the input of the alternating-current power source voltage to the converter (step S202).

In step S204, the switch control unit 14 determines whether or not the time clocked by the timer 21 reaches the predetermined time. As described above, the “predetermined time” is a value acquired in advance before the actual operation of the motor drive device 1000, and is set to, for example, a time required from when the electromagnetic contactor 104 is switched from the open state to the closed state to when the pre-charging of the capacitor 103 via the resistor 11 is completed. If it is determined in step S204 that the time clocked by the timer 21 reaches the predetermined time, the process proceeds to step S205.

In step S205, the switch control unit 14 switches the switch 12 from the open state to the closed state. Due to this, the pre-charging of the capacitor 103 is completed. After completion of the pre-charging of the capacitor 103, the direct-current output from the converter 101 flows toward the inverter 102 and the capacitor 103 through the switch 12 in the closed state, and is shifted to a state where the motor 3 can be driven.

As described above, according to one embodiment of the present disclosure, the timer 21 that starts clocking from the time point when the alternating-current power source voltage detecting unit 13 detects input of the alternating-current power source voltage to the converter 101 is provided, and when the time clocked by the timer 21 reaches the predetermined time, the switch 12 is switched from the open state to the closed state to complete the pre-charging of the capacitor 103.

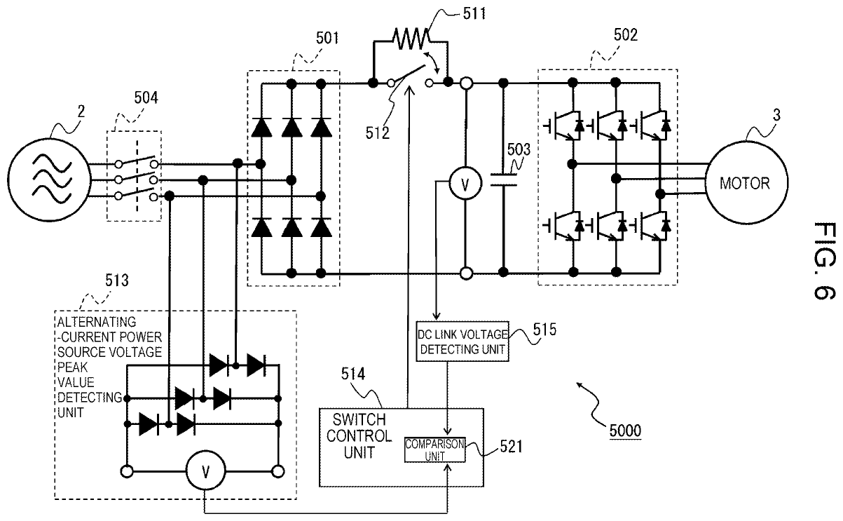

FIG. 6 is a view illustrating a conventional inrush current suppression circuit in which whether or not to complete pre-charging of a capacitor is determined based on a comparison result between an alternating-current power source voltage peak value and a DC link voltage. A conventional motor drive device 5000 illustrated in FIG. 6 includes a converter 501 that converts an alternating-current power source voltage supplied from the alternating-current power source 2 via an electromagnetic contactor 504 into a direct-current voltage, an inverter 502 that converts a direct-current voltage into an alternating-current voltage for driving the motor 3, a capacitor 503 provided between a direct-current output side of the converter 501 and a direct-current input side of the inverter 502, a resistor 511, a switch 512 connected in parallel to the resistor 511, and a switch control unit 514 that controls the switch 512. In the prior art, when it is determined whether or not to complete pre-charging of the capacitor 503 based on a comparison result between an alternating-current power source voltage peak value and a DC link voltage, it is necessary to provide an alternating-current power source voltage peak value detecting unit 513, a DC link voltage detecting unit 515, and a comparison unit 521 configured to compare the alternating-current power source voltage peak value and the DC link voltage, which makes the circuit complicated. Although the alternating-current power source voltage peak value detecting unit 513 detects the alternating-current power source voltage peak value by using a diode, there is a possibility that the diode is destroyed when a lightning surge occurs due to a lightning strike.

On the other hand, according to one embodiment of the present disclosure, as described with reference to FIGS. 1 to 5, the timer 21 that starts clocking from the time point when the alternating-current power source voltage detecting unit 13 detects input of the alternating-current power source voltage to the converter 101 is provided, and when the time clocked by the timer 21 reaches the predetermined time, the switch 12 is switched from the open state to the closed state to complete the pre-charging of the capacitor 103. Thus, it is not necessary to provide a circuit configured to detect each of the alternating-current power source voltage peak value and the DC link voltage and a circuit that compares the alternating-current power source voltage peak value and the DC link voltage, which simplifies the structure and lowers the cost. In the case of the embodiment of

FIGS. 1, 3, and 4, even if a lightning surge or the like occurs and an overvoltage occurs between the phases of each phase power line connected to the alternating-current input side of the converter 101, only a voltage of about a forward voltage is applied to any one of the two light emitting diodes in the alternating-current power source voltage detecting unit 13, and thus the light emitting diodes are not destroyed. As a result, the inrush current suppression circuit 1 including the alternating-current power source voltage detecting unit 13 does not fail and has a long life. In one embodiment of the present disclosure, even if a safety sequence for the motor drive device 1000 is set during a series of operations from when the control unit of the converter 101 commands start of pre-charging to when the electromagnetic contactor 104 is actually switched from OFF to ON, according to one embodiment of the present disclosure, since the switch 12 is switched from the open state to the closed state to complete the pre-charging of the capacitor 103 when the predetermined time has elapsed from the time point when the alternating-current power source voltage detecting unit 13 detects input of the alternating-current power source voltage to the converter 101, there is no influence of the safety sequence.

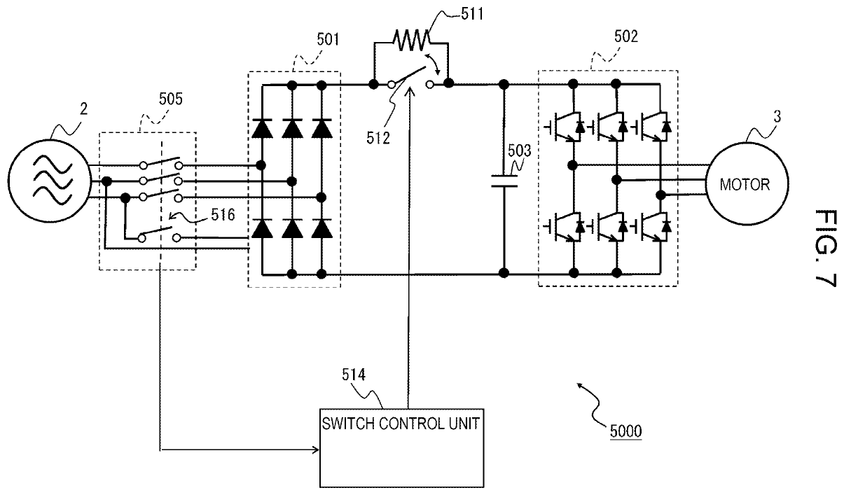

FIG. 7 is a view illustrating a conventional motor drive device in which the fact that the motor drive device is powered on is detected when an auxiliary contact of an electromagnetic contactor provided on an alternating-current input side of a converter is turned on. In a case where the motor drive device 5000 is configured to detect that the motor drive device 5000 is powered on when an auxiliary contact 516 of the electromagnetic contactor 505 provided on the alternating-current input side of the converter 501 is turned on, and to start the pre-charging of the capacitor 503 at this detection timing, it is necessary to provide a circuit and wiring configured to detect that the auxiliary contact 516 of an electromagnetic contactor 505 is turned on, which increases the man-hours by the operator to design and set the motor drive device 5000.

On the other hand, according to one embodiment of the present disclosure, as described with reference to FIGS. 1 to 5, since the alternating-current power source voltage detecting unit 13 configured to detect that the motor drive device 1000 is powered on can be easily constructed only by connecting the light emitting element 31 of the photocoupler in series between the phases of each phase power line connected to the alternating-current input side of the converter 101 and by connecting the light receiving element of the photocoupler to the switch control unit 14, it is possible to avoid an increase in the man-hours required by the operator to design and set the motor drive device 1000.

### REFERENCE SIGNS LIST

1 INRUSH CURRENT SUPPRESSION CIRCUIT
2 ALTERNATING-CURRENT POWER SOURCE
3 MOTOR
11 RESISTOR
12 SWITCH
13 ALTERNATING-CURRENT POWER SOURCE VOLTAGE DETECTING UNIT
14 SWITCH CONTROL UNIT
21 TIMER
31 LIGHT EMITTING ELEMENT
32 LIGHT RECEIVING ELEMENT
33 RESISTOR
34 DIODE
100 CONVERTER SYSTEM
101 CONVERTER
102 INVERTER
103 CAPACITOR
104 ELECTROMAGNETIC CONTACTOR
1000 MOTOR DRIVE DEVICE

1. An inrush current suppression circuit configured to suppress an inrush current during pre-charging of a capacitor connected in parallel to a direct-current output side of a converter that is configured to convert an alternating-current power source voltage into a direct-current voltage, the inrush current suppression circuit comprising:
a resistor provided between the direct-current output side of the converter and the capacitor or on an alternating-current input side of the converter;
a switch connected in parallel to the resistor and configured to selectively switch between an open state where an electric path via the resistor is formed and a closed state where a short circuit not via the resistor is formed;
an alternating-current power source voltage detecting unit configured to detect whether or not the alternating-current power source voltage is input to the converter; and
a switch control unit configured to switch the switch from the open state to the closed state after a predetermined time has elapsed since the alternating-current power source voltage detecting unit detects input of the alternating-current power source voltage to the converter.

2. The inrush current suppression circuit according to claim 1, wherein the switch control unit includes a timer configured to start clocking from a time point when the alternating-current power source voltage detecting unit detects input of the alternating-current power source voltage to the converter, and the switch control unit switches the switch from the open state to the closed state when a time clocked by the timer reaches the predetermined time.

3. The inrush current suppression circuit according to claim 1, wherein
the alternating-current power source voltage detecting unit includes a photocoupler including a light emitting element connected in series between phases of phase power lines connected to an alternating-current input side of the converter and a light receiving element connected to the switch control unit, and
wherein, when receiving light emitted from the light emitting element, the light receiving element outputs, to the switch control unit, a signal indicating that the alternating-current power source voltage is input to the converter.

4. The inrush current suppression circuit according to claim 3, wherein the light emitting element includes two light emitting diodes connected in antiparallel to each other.

5. A converter system comprising:
a converter configured to convert an alternating-current power source voltage into a direct-current voltage; and
the inrush current suppression circuit according to claim 1 that is connected to the converter.

6. A motor drive device comprising:
the converter system according to claim 5;
a capacitor connected in parallel to a direct-current output side of the converter in the converter system; and
an inverter connected to the direct-current output side of the converter via the capacitor, and configured to convert a direct-current voltage on the direct-current output side of the converter into an alternating-current voltage for driving a motor and output the alternating-current voltage.

7. The motor drive device according to claim 6 comprising an electromagnetic contactor configured to open and close an electric path between an alternating-current input side of the converter in the converter system and an alternating-current power source.
